(19) United States
(12) Patent Application Publication
(10) Pub. No.: US 2013/0077594 A1
(43) Pub. Date: Mar. 28, 2013

(54) COMMUNICATION METHOD AND COMMUNICATION APPARATUS FOR MTC IN A WIRELESS COMMUNICATION SYSTEM

(71) Applicants: Kyu Jin Park, Anyang-si (KR); Seung Hyun Kang, Anyang-si (KR); Han Gyu Cho, Anyang-si (KR)

(72) Inventors: Kyu Jin Park, Anyang-si (KR); Seung Hyun Kang, Anyang-si (KR); Han Gyu Cho, Anyang-si (KR)

(73) Assignee: LG ELECTRONICS INC., Seoul (KR)

(21) Appl. No.: 13/702,499

(22) PCT Filed: Jun. 9, 2011
(86) PCT No.: PCT/KR2011/004232

§ 371 Date: Dec. 6, 2012

Related U.S. Application Data
(60) Provisional application No. 61/353,227, filed on Jun. 10, 2010.
(60) Provisional application No. 61/357,973, filed on Jun. 23, 2010.

(51) Int. Cl. H04W 72/00

(52) U.S. Cl. CPC H04W 72/005
USPC 370/329

(57) ABSTRACT

The present invention relates to a communication method for machine type communication (MTC) in a wireless communication system. An MTC device transmits subscription information for indicating MTC subscribers to a base station, and receives a group identifier for indicating an MTC group to which the MTC device belongs, from the base station. The MTC device receives, from the base station, resource allocation information on a control channel based on the group identifier.

### TECHNICAL FIELD

The present invention relates to wireless communication and more specifically, to a communication method and communication apparatus for machine type communication (MTC) in a wireless communication system.

### BACKGROUND ART

As a wireless communication technology develops, various types of wireless communication systems other than general communication between a user and a base station are emerging.

Machine type communication (MTC) is a type of data communication that includes one or more entities not requiring interaction with a user. MTC means an idea where communication is carried out through a network by a machine device, not a terminal that a human being uses. MTC is also referred to as machine to machine (M2M).

A wireless device used for MTC is referred to as an MTC device. The MTC device includes an automatic vending machine, an electricity meter, a water level meter for a dam, etc. In comparison with the MTC device, a device requiring the interaction with a user is referred to as a human type communication (HTC) device.

The characteristics of the MTC device are different from those of the HTC device. First, the number of the MTC devices covered by a base station is much more than that of the HTC devices. Then number of the MTC devices may be hundreds to thousands in unit. Second, the amount of data transmitted by the MTC device and that of data received by the MTC device are smaller than the amount of data of the HTC device. In addition, the kinds of data transmitted and received are also finite.

In general, the HTC device and the base station use dedicated identifiers to send and receive signaling. The dedicated identifiers are ones used for identifying the HTC device. In comparison with this, group identifiers are used to manage a number of MTC devices. The group identifiers are ones used for identifying a group of MTC that includes a plurality of MTC devices.

The MTC devices may use the same functions or the same services. In addition, each MTC device may be assigned the same radio resources or different radio resources.

It is not disclosed how the base station allocates the group identifiers or how the radio resources are assigned using the group identifiers.

### DISCLOSURE

### Technical Problem

The present invention provides communication method and apparatus for MTC using a group identifier.

### Technical Solution

A communication method for machine type communication (MTC) in a wireless communication system is provided. The method includes transmitting, by an MTC device, subscription information to a base station, the subscription information indicating an MTC subscriber, receiving, by the MTC device, a group identifier from the base station, the group identifier indicating an MTC group to which the MTC device belongs, receiving, by the MTC device, resource assignment information on a control channel based on the group identifier from the base station, and transmitting or receiving data based on the resource assignment information by the MTC device.

The MTC group may be assigned by the base station based on the subscription information.

The cyclic redundancy check (CRC) of the resource assignment information may be masked with the group identifier.

The resource assignment information may include an index bitmap and a resource assignment bitmap. The resource assignment bitmap may include resource assignment to at least one MTC device and the index bitmap may include a bitmap indicating an MTC device corresponding to each resource assignment in the resource assignment bitmap.

The method may further include receiving, by the MTC device, assignment setting information from the base station. The assignment setting information may include a bitmap index that indicates the index of a corresponding MTC device in the index bitmap.

In another aspect, a wireless device for machine type communication (MTC) in a wireless communication system is provided. The wireless device includes a radio frequency (RF) unit configured to transmit and receive radio signals and a processor that operably connected to the RF unit and configured to transmit subscription information to a base station, the subscription information indicating an MTC subscriber, receive a group identifier from the base station, the group identifier indicating an MTC group to which the MTC device belongs, receive resource assignment information on a control channel based on the group identifier from the base station, and transmit or receive data based on the resource assignment information by the MTC device.

In another aspect, a communication method for machine type communication (MTC) in a wireless communication system is provided. The method includes receiving, by a base station, subscription information indicating an MTC subscriber from an MTC device, transmitting, by the base station, a group identifier to the MTC device, the group identifier indicating an MTC group to which the MTC device belongs, and transmitting, by the base station, resource assignment information on a control channel by using the group identifier to the MTC device.

### Advantageous Effects

The same group identifiers may be assigned to MTC devices for the same MTC subscribers. Radio resources may be assigned to the MTC devices using the group identifiers.

### DESCRIPTION OF DRAWINGS

FIG. 1 is an example of a communication scenario for MTC.

FIG. 2 illustrates a frame structure under IEEE 802.16ms.

FIG. 3 illustrates an example of a procedure configuring an assignment A-MAP.

FIG. 4 is a flow chart illustrating MTC communication according to an embodiment of the present invention.

FIG. 5 illustrates an example of resource assignment information.

FIG. 6 is a block diagram illustrating a wireless communication system where an embodiment according to the present invention is embodied.

### MODE FOR INVENTION

Machine type communication (MTC) is a type of data communication that includes one or more entities not requiring interaction with a human being.

An MTC device means a wireless device used for MTC and is also referred to as a machine-to-machine (M2M). The MTC device is a wireless device that transmits or receives data through a wireless channel.

An MTC subscriber is an entity that has a contractual relation with network operator so as to provide a service to one or more MTC devices.

An MTC group means a group of MTC devices that share one or more MTC characteristics and belong to the same MTC subscriber.

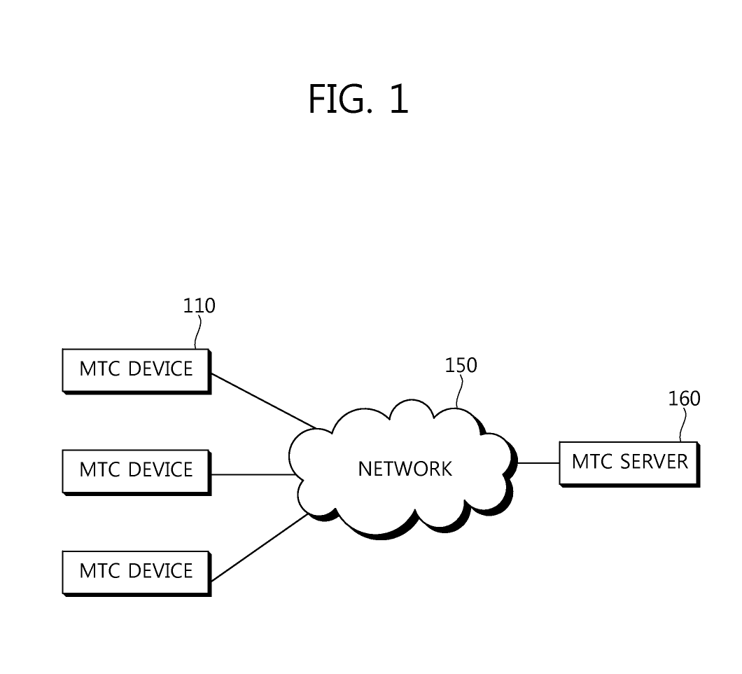

FIG. 1 is an example of a communication scenario for MTC.

MTC devices 110 are connected to an MTC server 160 through a network 150. The MTC server 160 receives information of the MTC device 110 through the network 150 and provides the information to an MTC subscriber.

The network 150 may be based on a well-known radio access technology (RAT) technology, such as GSM/EDGE radio access network (GERAN), UMTS terrestrial radio access network (UTRAN), or Evolved-UTRAN (E-UTRAN). A base station (BS) is a part of the network 150.

The MTC server 160 may be connected directly to the network 150 but may also be connected to the network 150 through internet protocol (IP).

Hereinafter, uplink (UL) means communication from the MTC device 110 to the base station and downlink (DL) means communication from the base station to the MTC device 110.

The service characteristics at MTC may be divided into the following categories.

Time Controlled: Data may be transmitted or received only to/from a section where an MTC device has previously been defined. It may be difficult for any section other than the previously defined section to make an access to a network.

Time tolerant: An MTC device may delay the reception or transmission of data. If there are insufficient available resources, a network may limit the access from an MTC device and dynamically limit the amount of data that the MTC device may transmit.

Low Data Usage: An MTC device may transmit or receive a predefined amount of data.

Group Based: MTC devices are used that belong to an MTC group. The MTC group includes a plurality of MTC devices that belong to the same MTC subscriber, and is identified by a group identifier.

Priority Alarm Message: If there is theft, vandalism, or any event requiring other urgent attention, an MTC device requiring priority alarm is used. The priority alarm may have precedence over any other categories.

The invention is now described that has been suggested based on Institute of Electrical and Electronics Engineers (IEEE) P802.16m/D5 “Part 16: Air Interface for Broadband Wireless Access Systems” (referred to hereinafter as IEEE 802.16m), posted in April, 2010.

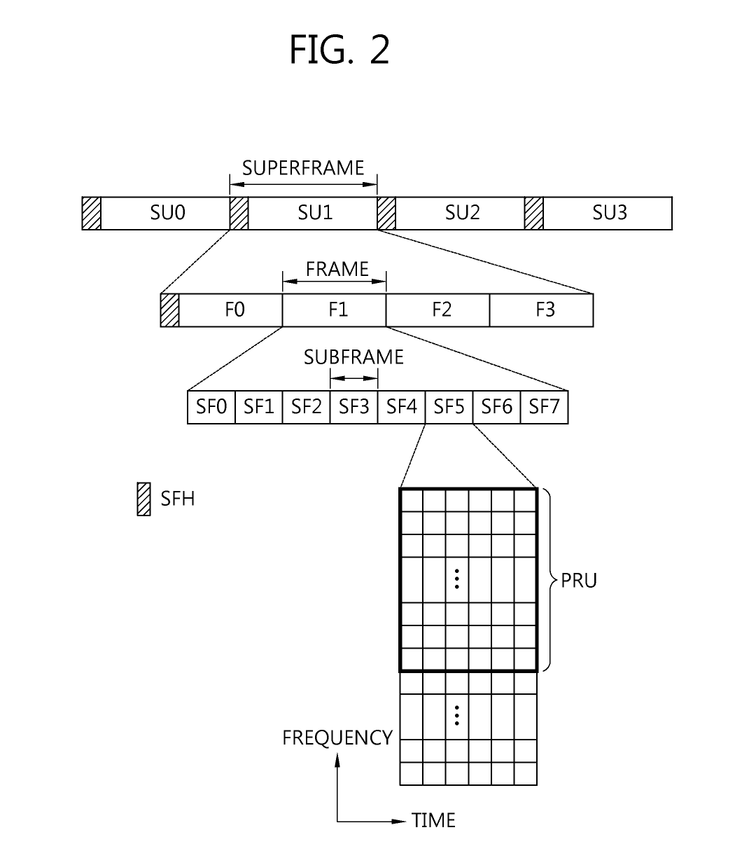

FIG. 2 illustrates a frame structure under IEEE 802.16ms.

Each of superframes SU0 to SU3 includes four frames F0 to F3. The length of the superframe is 20 ms and the length of each frame is 5 ms.

One frame includes 8 subframes SF 0 to SF7. Each subframe may be an uplink (UL) subframe or a downlink (DL) subframe. Depending on bandwidth and the length of cyclic prefix (CP), the number of the subframes include in a frame may vary.

A subframe includes a plurality of orthogonal frequency division multiple access (OFDMA) symbols in a time domain and a plurality of sub-carriers in a frequency domain. It is herein represented that one subframe includes 6 OFDMA symbols, but this is only an example.

Depending on the number of OFDMA symbols included in a subframe, the type of the subframe may be defined. For example, it may be defined that a type-1 subframe, a type-2 subframe, a type-3 subframe, and a type-4 subframe respectively include 6 OFDMA symbols, 7 OFDMA symbols, 5 OFDMA symbols, and 9 OFDMA symbols. One frame may include the same type of subframes. Alternatively, one frame may include different types of subframes.

IEEE 802.16m supports a time division duplex (TDD) mode and a frequency division duplex (FDD) mode. In the TDD mode, an UL subframe and a DL subframe are transmitted at the same frequency at different times. In the FDD mode, an UL subframe and a DL subframe may be transmitted at different frequencies at the same time.

A super frame header (SFH) is transferred from a first subframe of a first frame F0 of a superframe. The SFH may carry essential system parameters and system configuration information. The SFH may include primary-SFH (P-SFH) and secondary-SFH (S-SFH). The S-SFH may be divided into three sub-packets S-SFH SP1 to S-SFH SP3. Each sub-packet may be transferred regularly in different periods. The importance of information transferred through S-SFH SP1 to S-SFH SP3 may be different, S-SFH SP1 may be transferred in the shortest period, and S-SFH SP3 may be transferred in the longest period. S-SFH Sp1 includes information on network re-entry. S-SFH SP2 includes information on initial network entry and network discovery. S-SFH SP3 includes other important system information.

Physical resource unit (PRU) includes 18 contiguous sub-carriers and Nsym contiguous OFDMA symbols as a basic physical unit for resource assignment. Nsym may be determined depending on the type of a subframe. For example, if one subframe includes 6 OFDMA symbols, the value of Nsym is 6.

A logical resource unit (LRU) is a basic logical unit for distributed and continuous resource assignment.

A distributed logical resource unit (DLRU) may be used for obtaining a frequency diversity gain. The DLRU includes a sub-carrier group distributed in a frequency partition. A minimum assignment unit making an UL DLRU is referred to as a tile. The UL DLRU may include a sub-carrier group from three distributed tiles. The tile may be defined as 6 sub-carriers and Nsym OFDMA symbols.

A contiguous logical resource unit (CLRU) may be used for obtaining a frequency selective scheduling gain. The CLRU includes a sub-carrier group contiguous in a localized assigned resource. The CLRU includes data sub-carriers in a contiguous resource unit (CRU). The size of the CRU is the same as that of PRU.

An advanced-MAP (A-MAP) is a kind of a downlink control channel that carries control information. The control information transferred through the A-MAP is referred to as an information element (A-MAP IE). A region of each subframe where the A-MAP is transferred is referred to as an A-MAP region.

The A-MAP includes a non-user specific A-MAP, an HARQ feedback A-Map, a power control A-MAP, and an assignment A-MAP. The non-user specific A-MAP carries unlimited information to a specific user. The HARQ feedback A-MAP carries HARQ carries HARQ ACK/NACK information on an UL transmission. The power control A-MAP carries a power control command to a terminal. The assignment A-MAP carries resource assignment information. UL assignment or DL assignment to a specific terminal is included in assignment A-MAP IE.

In IEEE 802.16ms, a 12-bit station identifier (STID) is used as a dedicated identifier that identifies a terminal in a base station region. A base station assigns STID to a terminal in the process of network entry. A temporary SID (TSID) may be assign so as to protect mapping between STIDs.

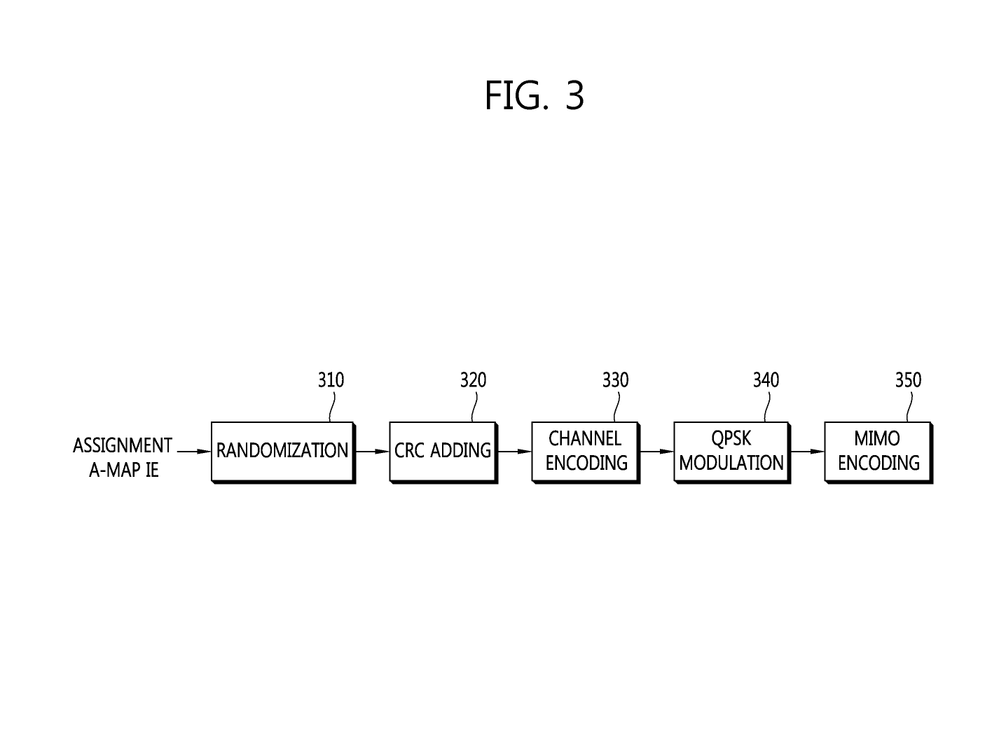

FIG. 3 illustrates an example of a procedure configuring an assignment A-MAP.

The information bit of the assignment A-MAP IE is masked and randomized by a sequence generated by a pseudo random binary sequence (PRBS) generator at block 310.

16-bit cyclic redundancy check (CRC) is added to a randomized bit sequence at block 320. CRC is masked with a CRC mask by using a bitwise XOR operation. The CRC mask includes a 1-bit masking prefix, a 3-bit type indicator, and a 12-bit STID (or TSTID). The masking prefix indicates whether to perform CRC mask. The type indicator indicates the presence or absence of STID or TSTID.

The sequence to which CRC has been added is encoded by tail-biting convolutional code (TBCC) at block 330.

The encoded bit sequence is modulated by using quadrature phase-shift keying (QPSK) at block 340.

The modulated sequence is transmitted through multiple-input multiple-output (MIMO) encoding at block 350.

The conventional IEEE 802.16m communication system has been designed with the aim of optimizing communication with an HTC device. Since MTC is introduced, conventional terminal identifiers may be insufficient since a number of MTC devices may be operated. For example, if one STID is assigned to one MTC device, a 12-bit STID may only identify up to 4096 (=2¹²) MTC devices.

Increasing the bit size of STID is not efficient since it may cause a significant modification to an existing system. Thus, a group identifier is used, which is used for identifying a plurality of MTC devices for MTC.

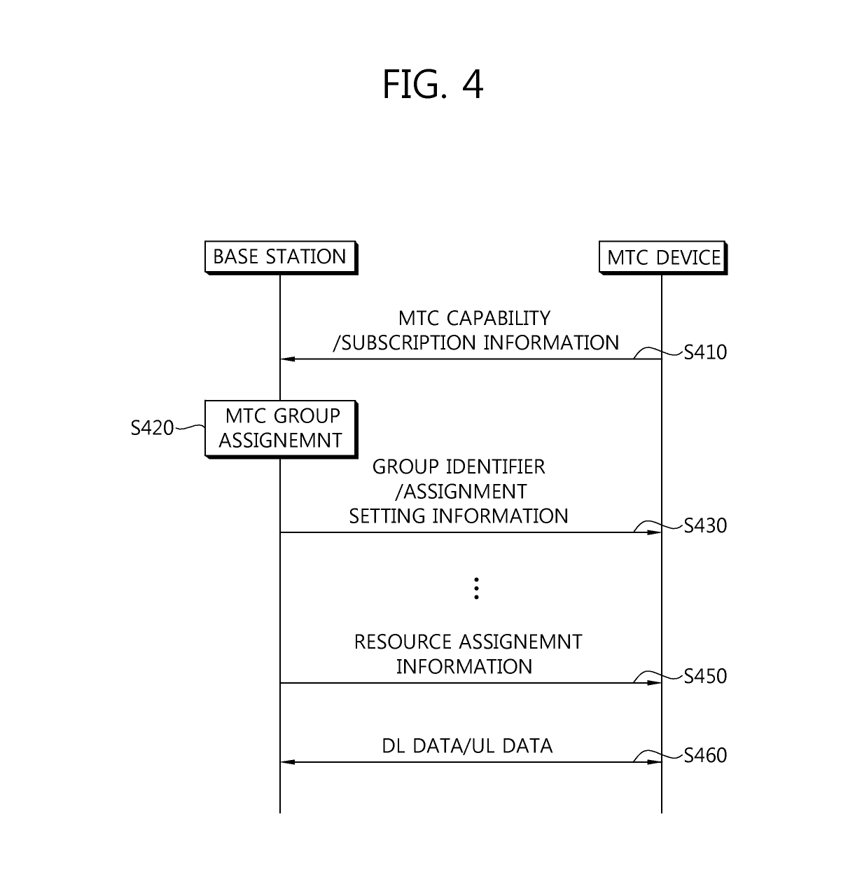

FIG. 4 is a flow chart illustrating MTC communication according to an embodiment of the present invention.

An MTC device sends an MTC capability and subscription information to a base station in step S410. The MTC capability and subscription information may be transmitted through one message or a separate message.

The MTC capability may include whether to support the MTC of an MTC device and/or categories for supported services.

The subscription information may include information for identifying an MTC subscriber (and/or an MTC server) (e.g. an identifier for an MTC subscriber). The subscription information may include services (or functions) that the MTC device will be provided.

The MTC capability and subscription information may be transmitted in the process of network entry, network re-entry or authentication after network entry.

A base station assigns an MTC group to an MTC device based on subscription information in step S420. For example, by using subscription information, the base station may identify an MTC subscriber to which the MTC device has been subscribed. The base station may assign the same MTC group to MTC devices which subscribe to the same MTC subscriber. As another example, the base station may identify a service (or function) for an MTC device by using subscription information. The base station may assign the same MTC group to MTC devices that provide the same service (or function).

The base station transmits group identifiers and/or assignment setting information to the MTC device in step S430. The group identifiers are used for identifying the assigned MTC group.

The assignment setting information may include common setting information that is required for all the MTC devices in an MTC group to receive resource assignment information from the base station. The common setting information may include a periodicity in which all the MTC devices in the MTC group receive resource assignment.

The assignment setting information may include dedicated setting information that is required for each of the MTC devices in the MTC to receive dedicated resource assignment information from the base station. Since all the MTC devices in the MTC group do not use the same resource, resources may be assigned to each of the MTC devices by using dedicated setting information.

The base station may use a bitmap to assign a dedicated resource to each MTC device in the MTC group. The bitmap includes an index bitmap and a resource assignment bitmap. The resource assignment bitmap includes resource assignment to each MTC device, and the index bitmap is used for indicating a corresponding MTC device in the resource assignment bitmap. The dedicated setting information includes a bitmap size and/or a bitmap index. The bitmap size represents the size of a corresponding index bitmap. The bitmap index is the index of a corresponding MTC device in an index bitmap.

The base station transmits resource assignment information to the MTC devices in step S450. The resource assignment information may be transmitted by using the A-MAP previously described, and the CRC mask of the A-Map may include a group identifier instead of STID. The MTC device may de-mask the group identifier to the CRC of the received A-MAP IE, and if a CRC error is not detected, the MTC device may confirm that it is an A-MAP for its MTC group. The resource assignment information may be DL resource assignment or UL resource assignment.

The MTC device receives DL data or transmits UL data, based on resource assignment information, in step S460.

The resource assignment information includes an index bitmap and a resource assignment bitmap. The index bitmap is a bitmap corresponding to a bitmap index in a resource assignment bitmap. For example, it is said that if the value of a bit corresponding to a bitmap index in an index bitmap is ‘1’, resource assignment to an MTC device corresponding to a resource assignment bitmap is not included. On the other hand, it is said that if the value of the bit is ‘0’, resource assignment to an MTC device corresponding to a resource assignment bitmap is not included.

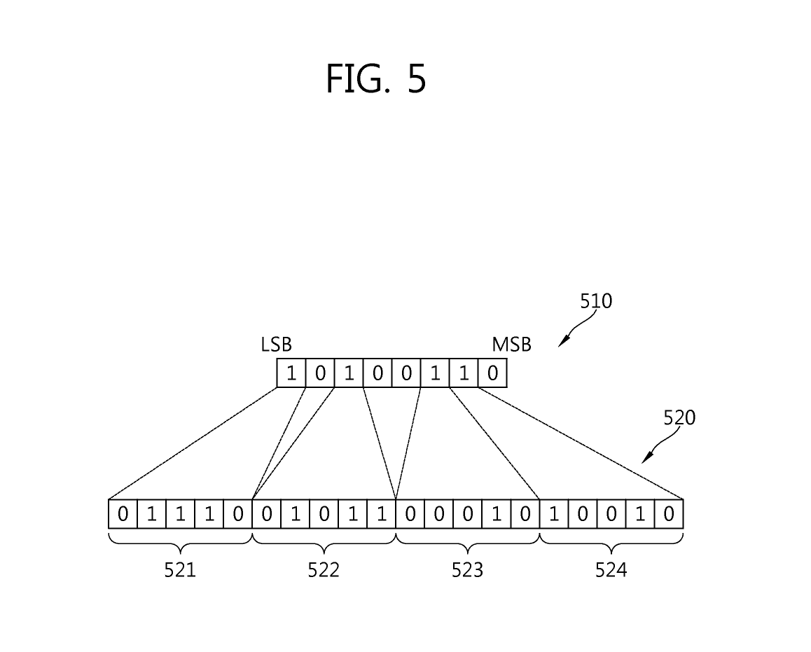

FIG. 5 illustrates an example of resource assignment information.

The resource assignment information includes an index bitmap 510 and a resource assignment bitmap 520. It is assumed that the size of the index bitmap 510 is 8 bit and the bitmap index of an MTC device is 3. Since the resource assignment information of each MTC device is 5 bit and there resource assignment information on four MTC devices, the size of the resource assignment bitmap 520 is 20 bit.

The MTC device first checks the value of a bit corresponding to its bitmap index from the index bitmap 510. The value of the third bit of the index bitmap 510 is ‘1’. Thus, the MTC device may recognize that its resource assignment is included in the resource assignment bitmap 520. Since the value of the first bit (or least significant bit (LSB)) of the index bitmap 510 is also ‘1’, the MTC device may recognize that the second resource assignment 522 of the resource assignment bitmap 520 is its resource assignment.

The size and value of the index bitmap and the size and value of the resource assignment bitmap are just examples and the technical spirit of the present invention is not limited to these.

As another embodiment, assignment setting information may include the number of MTC devices in an MTC group and the MTC indexes of the MTC devices in the MTC group. Resource assignment information may include an MTC index and resource assignment corresponding to the MTC index.

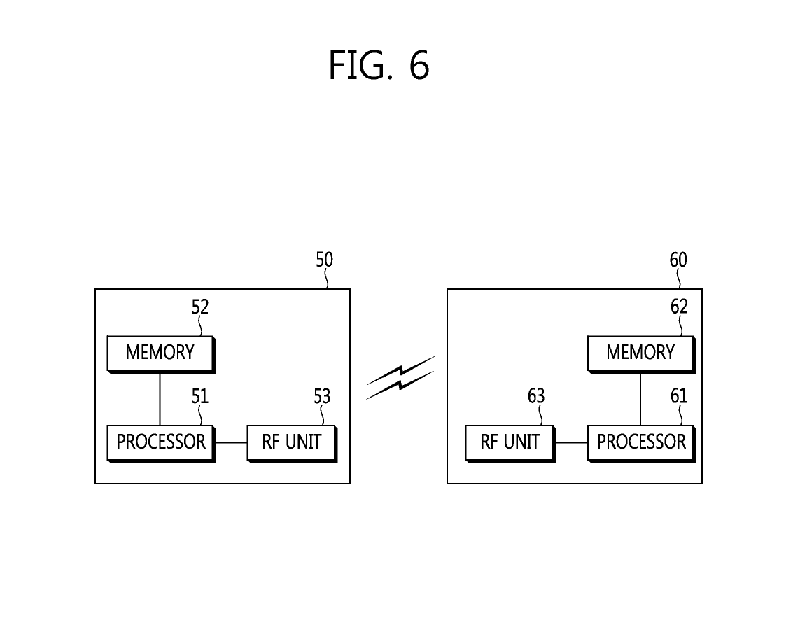

FIG. 6 is a block diagram illustrating a wireless communication system where an embodiment according to the present invention is embodied.

A base station 50 includes a processor 51, a memory 52, and a radio frequency (RF) unit 53. The memory 52 is connected to the processor 51 and stores various pieces of information to drive the processor 51. The RF unit 53 is connected to the processor 51, transmits and/or receives wireless signals. The processor 51 embodies the functions, processes and/or methods suggested. The operation of a base station in the embodiment of FIG. 4 may be embodied by the processor 51.

An RF device 60 includes a processor 61, a memory 62, and an RF unit 63. The memory 62 is connected to the processor 61 and stores various pieces of information to drive the processor 61. The RF unit 63 is connected to the processor 61, transmits and/or receives wireless signals. The processor 61 embodies the functions, processes and/or methods suggested. The operation of an MTC device in the embodiment of FIG. 4 may be embodied by the processor 61.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

1. A communication method for machine type communication (MTC) in a wireless communication system, the method comprising:
transmitting, by an MTC device, subscription information to a base station, the subscription information indicating an MTC subscriber;
receiving, by the MTC device, a group identifier from the base station, the group identifier indicating an MTC group to which the MTC device belongs;
receiving, by the MTC device, resource assignment information on a control channel based on the group identifier from the base station; and
transmitting or receiving data based on the resource assignment information by the MTC device.

2. The method of claim 1, wherein the MTC group is assigned by the base station based on the subscription information.

3. The method of claim 1, wherein the cyclic redundancy check (CRC) of the resource assignment information is masked with the group identifier.

4. The method of claim 3, wherein the resource assignment information includes an index bitmap and a resource assignment bitmap, the resource assignment bitmap including resource assignment to at least one MTC device, the index bitmap including a bitmap indicating an MTC device corresponding to each resource assignment in the resource assignment bitmap.

5. The method of claim 4, further comprising:
receiving, by the MTC device, assignment setting information from the base station, the assignment setting information including a bitmap index that indicates the index of a corresponding MTC device in the index bitmap.

6. The method of claim 5, wherein the assignment setting information further includes a bitmap size that indicates the size of the index bitmap.

7. The method of claim 3, wherein the control channel includes an Advanced-MAP (A-MAP).

8. A wireless device for machine type communication (MTC) in a wireless communication system, the wireless device comprising:
a radio frequency (RF) unit configured to transmit and receive radio signals; and
a processor that operably connected to the RF unit and configured to:
transmit subscription information to a base station, the subscription information indicating an MTC subscriber;
receive a group identifier from the base station, the group identifier indicating an MTC group to which the MTC device belongs;
receive resource assignment information on a control channel based on the group identifier from the base station; and
transmit or receive data based on the resource assignment information by the MTC device.

9. The device of claim 8, wherein the resource assignment information includes an index bitmap and a resource assignment bitmap, the resource assignment bitmap including resource assignment to at least one MTC device, the index bitmap being a bitmap indicating an MTC device corresponding to each resource assignment in the resource assignment bitmap.

10. The device of claim 9, wherein the processor is configured to receive assignment setting information from the base station, the assignment setting information including a bitmap index that indicates a corresponding RF device in the index bitmap.

11. A communication method for machine type communication (MTC) in a wireless communication system, the method comprising:
receiving, by a base station, subscription information indicating an MTC subscriber from an MTC device;
transmitting, by the base station, a group identifier to the MTC device, the group identifier indicating an MTC group to which the MTC device belongs; and
transmitting, by the base station, resource assignment information on a control channel by using the group identifier to the MTC device.

12. The method of claim 11, further comprising:
assigning, by the base station, the MTC group based on the subscription information.

13. The method of claim 11, wherein the cyclic redundancy check (CRC) of the resource assignment information is masked with the group identifier.

14. The method of claim 13, wherein the resource assignment information includes an index bitmap and a resource assignment bitmap, the resource assignment bitmap including resource assignment to at least one MTC device, the index bitmap being a bitmap indicating an MTC device corresponding to each resource assignment in the resource assignment bitmap.

15. The method of claim 14, wherein the resource assignment information includes an index bitmap and a resource assignment bitmap, the resource assignment bitmap including resource assignment to at least one MTC device, the index bitmap being a bitmap indicating an MTC device corresponding to each resource assignment in the resource assignment bitmap.
